(19) United States
(12) Patent Application Publication
(10) Pub. No.: US 2026/0042677 A1
(43) Pub. Date: Feb. 12, 2026

(54) METHOD

(71) Applicant: Watercycle Technologies Ltd, Manchester (GB)

(72) Inventors: Sebastian James Allender Leaper, Manchester (GB); Ahmed Abdelkarim, Manchester (GB)

(73) Assignee: Watercycle Technologies Ltd, Manchester (GB)

(21) Appl. No.: 19/130,935

(22) PCT Filed: Nov. 17, 2023
(86) PCT No.: PCT/EP2023/082288

§ 371 Date: May 16, 2025

(30) Foreign Application Priority Data
Nov. 18, 2022 (GB) 2247313.2

(51) Int. Cl. C01D 15/02; H01M 10/54

(52) U.S. Cl. CPC C01D 15/02; H01M 10/54

(57) ABSTRACT

A method of extracting lithium hydroxide from a lithium containing solid such as lithium ore or lithium batteries. The problem addressed by the invention is the provision of an extraction method where non-lithium components are removed sequentially rather than concomitantly. The method of the invention includes the sequential steps of: dissolving the lithium-containing solid in an acid, precipitating non-lithium metal products using a first base, precipitating the conjugate base of said acid using a second base, and isolating lithium hydroxide from the resultant solution.

### FIELD OF THE INVENTION

The present invention relates to a method of processing materials containing metals to extract or recover metals and other compounds suitable for further use. More particularly, the invention provides a method of extracting lithium from lithium-containing solids such as black mass recovered through battery recycling.

### BACKGROUND

There is increasing demand in the world for batteries, and in particular lithium-ion batteries as use of electric vehicles increases. Lithium is therefore a valuable resource, obtained from the environment either through mining lithium ore or extraction of mineral rich-salt lake brine. Both methods have environmental impact, with brine extraction thought to risk soil salinization and demand to the local eco-structure and landscape, while mining requires large areas and often scars the landscape for generations. Lithium mining and processing also involves significant water consumption, with considerable risk of affecting local water supplies and aquaculture through leeching of by-products.

Lithium hydroxide (specifically, lithium hydroxide monohydrate) is one of two main forms of lithium used to produce lithium-ion batteries, the other being lithium carbonate. Typically, the production of lithium hydroxide requires energy-intensive electrolytic methods or additional precipitation steps compared to lithium carbonate.

There is therefore considerable interest in improved methods for lithium extraction and in recovering and reusing lithium.

Black mass is a type of waste product formed through the recycling of lithium-ion batteries. During battery recycling, the lithium-ion battery is dismantled and the portions rich in lithium are shredded to produce so called ‘black mass’. This lithium-rich material comes from the electrodes of batteries and contains various other elements such as nickel, manganese, and cobalt. Therefore, processing is required to separate these elements before being reused in battery production.

A well-known method of recovering elements from black mass is the leaching-precipitation method. This involves dissolving the black mass in an acid, such as sulfuric acid, and then subsequently adding a reagent to raise the pH, for example sodium hydroxide. The first step brings the metals (that may include lithium, nickel, manganese, cobalt) into solution and the second step causes the majority of metals to precipitate while soluble elements such as lithium remain in solution from which they can subsequently be recovered. However, when sodium hydroxide is used sodium remains in solution with the lithium and must subsequently be removed

The use of metal hydroxides such as barium hydroxide and calcium hydroxide has also been proposed. Due to the low solubility of barium sulfate or calcium sulfate, when sufficient hydroxide compound is added to the dissolved black mass, the barium or calcium sulfate precipitates out together with the other insoluble metals in a single step, leaving only lithium hydroxide behind. It is reported that only a drying step is required to produce the solid lithium hydroxide product (KR101975468B1).

Similar techniques can be applied to other solid sources of lithium, such as lithium-based anodes or lithium-containing ores such as spodumene, mica or lepidolite.

### SUMMARY OF THE INVENTION

The present inventors sought to provide an improved and more environmentally friendly method for the extraction of lithium hydroxide from a lithium-rich material such as chopped lithium battery electrodes or similar (so-called black mass). In doing so, the inventors propose a multi-step precipitation method from a liquor formed by treating the lithium-rich material with an acid, such as sulfuric acid. In a first precipitation step, the so-called insoluble metals are recovered in a mixed metal product (these may include, if present in the original material, nickel, cobalt, and manganese in addition to other elements/compounds present in the original material, such as post-transition metals such as aluminium). In a second precipitation step the conjugate base of the acid is precipitated, for example if sulfuric acid is used then a sulfate compound(s) is recovered. The resultant lithium hydroxide solution can then be dried or subjected to a further precipitation to recover lithium hydroxide solution.

The lithium-rich material may suitably be a lithium-containing solid. It might be, for example, a natural (mined) material such as spodumene, mica or lepidolite, or a man-made material such as black mass or lithium-containing anodes.

Accordingly, in a first aspect, the invention may provide a method for extracting lithium hydroxide from a lithium-containing solid, the method comprising:
(i) a dissolution step comprising treating the lithium-containing solid with an acid to obtain to obtain a dissolution step liquor;
(ii) a first precipitation step comprising adding a first base to said dissolution step liquor to precipitate metal products as a first precipitate, then isolating the first precipitate to leave a first precipitation step liquor;
(iii) a second precipitation step comprising adding a second base to the first precipitation step liquor to precipitate compounds containing the conjugate base of the acid as a second precipitate, then isolating the second precipitate to leave a second precipitation step liquor;
(iv) isolating lithium hydroxide from the second precipitation step liquor.

Suitably, the second base is a metal hydroxide (such as an alkaline earth metal hydroxide) or a metal oxide (such as an alkaline earth metal oxide, which when added to water reacts to form an alkaline earth metal hydroxide). Most suitably an alkaline earth metal hydroxide is used.

The first and the second base may be the same or different. Preferably, they are different.

The inventors observe that use of a multi-step precipitation process may have the following advantages: (1) the mixed metal product (first precipitate, which may be referred to as reprecipitated black mass when the lithium-containing solid is black mass) may contain fewer contaminants, such as barium, and therefore be more useful and/or have higher value; (2) the cost of reagents may be lower; and/or (3) a third material stream can be recovered in addition to the mixed metal product and lithium hydroxide, namely the precipitate recovered in the second precipitation step. This may be itself used or further processed; in other words, it may be recycled.

As is conventional, processing of the lithium-containing solid begins with addition of an acid to dissolve the lithium-containing solid, thus creating a dissolution step liquor. This may be referred to in the art as ‘dissolving’ or ‘leaching’ the black mass, where the lithium-containing solid is black mass.

The acid may be, for example, selected from sulfuric acid, phosphoric acid, hydrochloric acid, citric acid and oxalic acid. In some embodiments it is sulfuric acid.

Conventionally, concentrated (for example 98 wt %, 18 M) sulfuric acid can be used. Other acids that can be used include mineral acids such as concentrated (for example 85 wt %, 15 M) phosphoric acid, and concentrated (for example 37 wt %, 12 M) hydrochloric acid as well as organic acids such as citric acid, and oxalic acid.

When using acids which are solid at room temperature, for instance citric acid and oxalic acid, concentrated solutions of the acids can be employed. For instance at room temperature 55-65 wt % (for example 59.2 wt %) citric acid solution or 9 wt % oxalic acid solution can be used. More concentrated acid solutions can be formed using heating, for example 76.2 wt % citric acid solution can be used at 70° C.

The ratio of acid to lithium-containing material being used is not particularly limited as it will depend on the lithium-containing material and acid being used. For instance, a larger number of moles of a monoprotic acid, such as hydrochloric acid, will be required in comparison to a diprotic acid, such as sulphuric acid. The ratio of acid to lithium-containing material may be from 5-100 moles of acid to 1 kg of lithium containing material.

Suitably, when concentrated (for example 96%, 18 M) sulfuric acid is used. The ratio of sulfuric acid to lithium-containing material may be, for example, 10-40 moles of sulfuric acid to 1 kg of lithium-containing solid, suitably 15-30 or 20-25 moles of sulfuric acid to 1 kg of lithium-containing solid. A suitable example is about 23 moles of sulfuric acid to 1 kg of black mass.

Suitably, when concentrated (for example 37 wt %, 12 M) hydrochloric acid is used. The ratio of hydrochloric acid to lithium-containing material may be, for example, 20-80 moles of hydrochloric acid to 1 kg of lithium-containing solid, suitably 30-60 or 40-50 moles of hydrochloric acid to 1 kg of lithium-containing solid. A suitable example is about 46 moles of hydrochloric acid to 1 kg of black mass.

The dissolution step can be performed at room temperature or can be performed above room temperature, for example at 40-80° C., suitably 60-65° C. such as about 70° C. This is advantageous as the elevated temperature increases the rate of dissolution and increases the solubility of the metal salts.

Optionally, an additional step of heating the lithium-containing solid is performed before the dissolution step. The purpose of such a heating step is to remove volatile and/or organic components. Heating can be done, for example, until no change in mass is observed. Preferably the heating step is done at 50-100° C., optionally 60-80° C., optionally 65-75° C. and in some embodiments at about 70° C.

Optionally, an additional step of filtering the dissolution step liquor is performed after the dissolution step but before the first precipitation step. This can remove insoluble components such as carbon (in the form of graphite) and metals resistant to dissolution by acids, such as gold and copper. This allows for such metals to be recovered, and improves the purity of the precipitate produced in the first precipitation step.

In some embodiments, before the first precipitation step, the dissolution step liquor is diluted; however, more conveniently it is not diluted before the first precipitation step.

In the first precipitation step, a base (the so-called first base) is added to the dissolution step liquor to raise the pH. The base can be provided as a solid, liquid or aqueous solution. Preferably, the base is water soluble (an alkali) as homogeneous solutions react more rapidly than heterogeneous mixtures.

The pH of the solution is increased to precipitate the so-called insoluble metals from the dissolution step liquor as a first precipitate. The term ‘insoluble metals’ is understood in the art and refers to those metals whose relevant salt(s) (for example, hydroxides if the first base is a source of hydroxide ions; sulfides if the first base is a source of sulfide ions) are not soluble (<1 mg/mL, suitably <0.5 mg/mL, more suitably <0.1 mg/mL) in the liquor generated by addition of the first base to the dissolution step liquor. The composition of the first precipitate will depend on what was present in the original lithium-containing solid used and on the base used in the first precipitation step. Typically, the precipitate will comprise hydroxides of the insoluble metals (in particular where the first base is a source of hydroxide ions). The precipitate may also comprise sulfides, oxides, or carbonates of the insoluble metals. The first precipitate may also comprise the base used in the first precipitation step. Typically the first precipitate will comprise insoluble compounds of nickel, cobalt and manganese. Suitable bases for use in the first precipitation step may include ammonium persulfate, ammonium carbonate, aqueous ammonia, barium hydroxide and calcium hydroxide.

In some embodiments, the first base is not an alkali metal-containing base; the use of alkali metal containing bases may be undesirable as the introduction of alkali metal anions can contaminate the lithium hydroxide product.

In some preferred embodiments, the first base is ammonium persulfate, ammonium carbonate or aqueous ammonia, and particularly is suitably ammonium persulfate. The use of an ammonium base is advantageous because the ammonium cations can be readily removed from the first precipitate (for example, reprecipitated black mass) by heating. In general, fewer impurities in the first precipitate (reprecipitated black mass) mean that it may be more suitable for reuse and/or have higher resale value, requiring less processing.

The amount of the first base required to precipitate the transition metals depends on the amount of acid used and the composition of the lithium-containing solid. Preferably, at least an equimolar amount of base to acid is used. For diprotic acids, such as sulphuric acid, at least two moles of base is used per mole of acid. For triprotic acids, such as phosphoric acid, at least three moles of base is used per mole of acid.

The solubility of transition metal hydroxides varies dependent on the metallic species and the pH of the solution. Typically, metal hydroxides are soluble at low pH (around pH 0) and at high pH (around pH 14), with low solubilities at intermediate pH. For example, the lowest solubility for aluminium is around pH 6-7; for iron, pH 7-9; for nickel, pH 10-10.5; for cobalt, pH 10-12; and for manganese, pH 11-12. However, some metals will start precipitating around pH 3, for example iron.

Therefore, the optimum pH for the first precipitation step varies depending on the composition of the lithium-containing solid. In the first precipitation step a quantity of the first base sufficient to raise the pH of the liquor to pH 3-12 may preferably be added.

After addition of the first base in the first precipitation step, the precipitated metal products may be isolated by any suitable means to afford a first precipitate and first precipitation liquor. This includes, but is not limited to, gravity settling, filtration, centrifugation, and hydrocyclonic separation.

The liquor obtained after the first precipitation (first precipitation liquor) is then treated with a metal base (the so-called second base).

Suitably the second base is an alkaline earth metal hydroxide such as barium or calcium hydroxide, or an alkaline earth metal oxide such as barium or calcium oxide (which form the corresponding hydroxides on reaction with water), preferably barium hydroxide. Barium hydroxide is preferred due to its high aqueous solubility and the resulting barium salts often have low aqueous solubilities.

Suitably, when sulfuric acid is used as the acid in the dissolution step, the second base is barium hydroxide or calcium hydroxide. Barium hydroxide is preferred as barium sulfate has an extremely low aqueous solubility (0.24 mg/L at 20° C.). whereas Calcium sulfate has a higher solubility (2.6 g/L at 25° C.) When phosphoric acid is used as the acid in the dissolution step, the second base is preferably barium hydroxide or calcium hydroxide. Barium phosphate is insoluble in water, calcium phosphate has a solubility of 0.002 g/L at 20° C.

When hydrochloric acid is used as the acid in the dissolution step, the second base is preferably barium hydroxide, Barium chloride has a solubility of 358 g/L at 20° C.

When citric acid is used as the acid in the dissolution step, the second base is preferably barium hydroxide or calcium hydroxide. Barium citrate has a solubility of 0.406 g/L, calcium citrate has a solubility of 0.85 g/L at 18° C.

When oxalic acid is used as the acid in the dissolution step the second base is preferably barium hydroxide or calcium hydroxide. Barium oxalate has a solubility of 0.003 g/L at 20° C., calcium oxalate has a solubility of 6.7 mg/L at 20° C.

The base used for the first and second precipitation steps can be the same, for example the first base and the second base can both be barium hydroxide. However, the use of different bases is preferable as a less expensive and less toxic first base can be used, for example ammonium persulfate.

The first precipitation liquor contains lithium salts formed when the lithium-rich material is treated with the acid. By adding a alkaline earth metal hydroxide base (or forming one in situ by the addition of the corresponding oxide), a double displacement reaction is performed, forming lithium hydroxide, which remains in solution, and alkaline earth compounds containing the conjugate base of the acid which precipitate out of solution and can be isolated from the liquid by any suitable method. This includes, but is not limited to, gravity settling, filtration, centrifugation, or hydrocyclonic separation.

The amount of the second base required to precipitate the acid conjugate base ions depends on the amount of acid used and the amount of base used in the first precipitation step. The amount of second base can be calculated by, for example, measuring the concentration of acid conjugate base ions, such as sulfate ions when sulfuric acid is used, in the first precipitation liquor and adding equimolar amount of the second base. The concentration of acid conjugate base ions in the first precipitation liquor may be found using titration and the like. Methods of titrating sulfate, phosphate, chloride, citrate and oxalate are known in the art.

Alternatively, the second base can be added in aliquots until no further precipitation is observed. Precipitation can be observed using, for example, an inline camera.

As most impurities have already been isolated in the first precipitation step, the inventors observe that the precipitate isolated in the second precipitation step may be sufficiently pure to be suitable for further use. This reduces waste and/or makes the process more cost-effective. Further use includes recycling into barium hydroxide, and selling the barium salts, when barium compounds are used as the second base.

After addition of the base in the second precipitation step, the precipitated compounds containing the conjugate base of the acid may be isolated by any suitable means to afford a second precipitate and a second precipitation liquor. This includes, but is not limited to, gravity settling, filtration, centrifugation, or hydrocyclonic separation.

After the second precipitation step is complete, a solution of lithium hydroxide is obtained (the second precipitation step liquor). This may be evaporated to obtain the lithium hydroxide, or the lithium hydroxide may be precipitated, for example, using antisolvent precipitation/recrystallization. Suitable lithium hydroxide precipitation methods will be apparent to the skilled person.

The claimed processes are advantageous when compared to the leaching method of the prior art in which the type and amount of reagent makes the process expensive. This can detrimentally affect the economics of the process. Furthermore, in order to fully remove all impurities from the solution in the methods of the prior art, significant quantities of the metal hydroxide are needed. This then ends up in the first precipitate (such as reprecipitated black mass) and may be treated as an impurity which reduces the quality and therefore the market value of the precipitate (reprecipitated black mass).

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a flow chart of the process described in the prior art.

FIG. 2 shows a flow chart of the process of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Lithium-Containing Solids

The lithium-containing solid used in the dissolution step of the invention is not particularly limited. Any suitable material may be used. This includes both natural (mined) and man-made materials. Natural (mined) lithium-containing solids include ores such as spodumene, mica and lepidolite. Man-made lithium-containing solids include recycling waste streams such as black mass and lithium-containing anodes.

Recycled materials can often have significantly higher percent-by-mass of lithium when compared to natural (mined) sources. For example black mass contains approximately 5% lithium by mass whereas lithium ores (namely spodumene) typically have only 3% lithium by mass. However, these man-made sources also contain very high amounts of transition metals which can complicate separation of lithium. These transition metals may also be valuable by-products.

The present invention describes a process for obtaining useful products, including particularly lithium hydroxide, from lithium-containing solids. The inventors believe that the process is effective and may be more economical and/or environmentally friendly than methods used for this purpose in the prior art. It may be used to extract lithium from so-called natural sources, such as ores, or from recycled material such as spent batteries (through treatment of black mass or a lithium-containing anode material).

### Black Mass

Black mass is a term well-recognised in the art. It is typically formed from recycling lithium-ion batteries, although other lithium-based batteries may be used. The lithium-rich electrode material (which may be cathode, anode, or both) is chopped up, broken up and/or ground in a mechanical treatment in the first stage of battery recycling.

Black mass can have varying elemental compositions, depending on the source battery type (lithium ion, lithium polymer, lithium cobalt oxide, lithium iron phosphate, and the like). Often, black mass is largely carbon (in the form of graphite), nickel, lithium and cobalt. Black mass often contains: lithium, carbon, fluorine, sodium, magnesium, aluminium, manganese, iron, cobalt, nickel, copper, zinc, phosphorous.

The source of the black mass is not particularly limited; any lithium-containing battery materials can be used in the process of the invention. For example, black mass may be formed of one or more battery types selected from the group of: lithium nickel manganese cobalt oxide (NMC), lithium nickel cobalt aluminium oxide (NCA), lithium iron phosphate (LFP), lithium manganese oxide (LMO), and lithium cobalt oxide (LCO).

In some embodiments, the black mass is derived from an NMC or LFP battery. In some embodiments, the black mass is derived from an NMC battery.

### Process According to the Invention

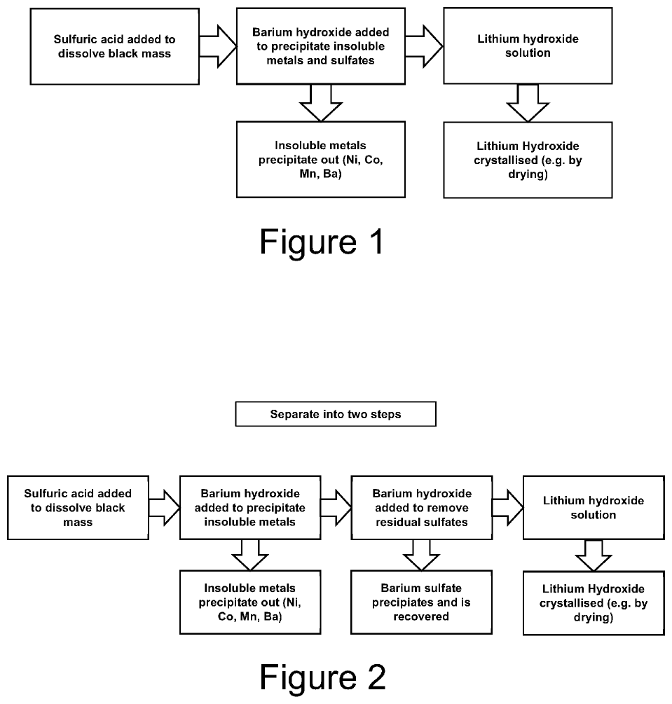

A process comprising a two-step precipitation according to the method of the invention is shown schematically in FIG. 2. This can be contrasted to the prior art method schematically shown in FIG. 1 which features a single precipitation step.

### Dissolution Step

Where the lithium-containing solid is black mass, this step may be referred to as ‘dissolving the black mass’ or ‘leaching’ and is used in the methods of the prior art as a first step in the chemical processing of lithium-ion battery waste. The acid reacts with metals, metal oxides, and other metal compounds in the black mass, converting them to salts which are soluble in the liquor.

In one embodiment in the dissolution step, sulfuric acid is added to the lithium-containing solid, in this case black mass. In some embodiments, for each kilogram of black mass 1-50 moles of sulfuric acid is used, optionally 10-40 moles, optionally 20-30 moles, optionally 20-25 moles, optionally 22-24 moles, optionally 23 moles. In some embodiments, the ratio of lithium-containing solid (such as black mass) to sulfuric acid is 100-10,000 g/L, optionally 200-5,000 g/L, optionally 400-2000 g/L, optionally 600-1200 g/L, optionally 700-900 g/L, optionally 800 g/L.

The sulfuric acid may be used as a 90-100% concentrated solution (by mass, in water).

In other embodiments, phosphoric acid may be used, Phosphoric acid may be used as a 75-100% concentrated solution (by mass, in water).

In other embodiments, hydrochloric acid may be used. Hydrochloric acid may be used as a 30-40% concentrated solution (by mass, in water).

In other embodiments, citric acid may be used. Citric acid may be used as a 40-85% solution (by mass, in water).

In other embodiments, oxalic acid may be used. Oxalic acid may be used as a 5-15% solution (by mass, in water).

In some embodiments the dissolution step is performed at room temperature. In some embodiments the dissolution step is performed at above room temperature, for example 50-100° C., optionally 60-90° C., optionally 70-80° C.

In some embodiments, an additional step of heating the lithium-containing solid is performed before the dissolution step. In some embodiments this is done at a temperature of 50-100° C., optionally 60-80° C., optionally 65-75° C. and in some embodiments at about 70° C.

In some embodiments, an additional step of removing solids from the dissolution step liquor is performed after the dissolution step. For example, the mixture may be separated by gravity separation, filtration, centrifugation, hydrocyclonic separation or the like.

### First Precipitation Step

The dissolution step liquor is treated with a first base, barium hydroxide in the scheme of FIG. 2, to raise the pH. This precipitates insoluble metals (as the so-called first precipitate described herein).

This precipitate typically contains nickel, cobalt and manganese. It may also contain magnesium, aluminium, iron, copper and zinc. It may also include metal from the first base used, for example barium. Clearly the content will depend on what was in the lithium-containing solid and the first base.

As alternatives for the first base, calcium hydroxide or ammonium persulfate, ammonium carbonate or ammonia may be used. These may be less expensive than barium hydroxide. Other suitable bases for use in the first precipitation step may include alkaline earth metal hydroxides such as Mg(OH)₂, Ca(OH)₂, Sr(OH)₂ or Ba(OH)₂, alkaline earth metal oxides (which hydrate to provide alkaline earth metal hydroxides) such as MgO, CaO, SrO or BaO, alkaline earth metal carbonates such as MgCO₃, CaCO₃, SrCO₃ or BaCO₃, alkaline earth metal sulfides such as MgS, CaS, SrS or BaS, ammonia, ammonium hydroxide, ammonium carbonate, ammonium persulfate, and organic amines.

In some embodiments, by adding the first base the pH is raised to 3 or more, optionally 4 or more, optionally 5 or more, optionally 6 or more, optionally 7 or more, optionally 8 or more, optionally 9 or more, optionally 10 or more, or optionally 11 or more. Suitably the pH is raised to 12 or lower, optionally 11 or lower, optionally 10 or lower, optionally 9 or lower, optionally 8 or lower, optionally 7 or lower, optionally 6 or lower, optionally 5 or lower, or optionally 4 or lower. A suitable range for the pH after addition of the first base is 3-12.

The precipitated metal products (that is, the first precipitate) are separated from the first precipitation liquor. For example, the mixture may be separated by gravity separation, filtration, centrifugation, hydrocyclonic separation or the like. This provides a mixed metal product as the first precipitate, also referred to as reprecipitated black mass when the lithium-containing solid was black mass. By using only the amount of base required to precipitate the metals while leaving the conjugate base of the acid in solution, the first precipitate should be of higher purity and therefore greater usefulness/monetary value than precipitates formed by the methods of the prior art.

### Second Precipitation Step

The liquid remaining after separation of the first precipitate, referred to herein as the first precipitation step liquor, is then treated with a second base.

This is suitably a metal hydroxide, for example barium or calcium hydroxide (barium hydroxide is used in the example of FIG. 2). Suitably, it is not sodium hydroxide as the sodium remains in solution and must be separated from the lithium hydroxide product.

For example, when sulfuric acid is used as the dissolution step acid, this step precipitates barium sulfate (or other sulfate depending on the second base used), removing impurity from the liquor but also recovering the sulfate for use, further processing or re-sale, making the process more environmentally friendly. The resultant lithium hydroxide solution has low sulfate levels; the resultant sulfate precipitate is substantially free of impurities in the form of the insoluble metals (or sulfates/hydroxides thereof) which were removed by the first precipitation step.

Analogously, when phosphoric acid or hydrochloric acid is used, the precipitate contains phosphate anions or chloride anions, respectively, similarly for oxalic acid and citric acid, the precipitate contains oxalate and citrate anions, respectively.

The second base is suitably an alkaline earth metal hydroxide such as Mg(OH)₂, Ca(OH)₂, Sr(OH)₂ or Ba(OH)₂, or an alkaline earth metal oxide (which hydrate to provide corresponding alkaline earth metal hydroxides) such as MgO, CaO, SrO or BaO. Preferably the second base is soluble in water therefore Ca(OH)₂ or Ba(OH)₂ is preferred.

After the addition of the second base, the second precipitate is separated from the second precipitation liquor. For example, the mixture may be separated by gravity separation, filtration, centrifugation, hydrocyclonic separation and the like.

### Lithium Hydroxide Isolation Step

The second precipitation step liquor is a lithium hydroxide solution. The lithium hydroxide may be isolated as the monohydrate (LiOH·H₂O) or the anhydrate (LiOH) through evaporation of the liquid or by crystallisation. Suitable crystallisation techniques include antisolvent crystallisation wherein lithium hydroxide precipitates from solution upon addition of a suitable organic solvent such as acetone. The antisolvent may then be recovered after separation of the solid lithium hydroxide by, for example, distillation.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
KR101975468B1

1. A method for extracting lithium hydroxide from a lithium-containing solid, the method comprising:
(i) a dissolution step comprising treating the lithium-containing solid with an acid to obtain to obtain a dissolution step liquor;
(ii) a first precipitation step comprising adding a first base to said dissolution step liquor to precipitate metal products as a first precipitate, then isolating the first precipitate to leave a first precipitation step liquor;
(iii) a second precipitation step comprising adding a second base to the first precipitation step liquor to precipitate compounds containing the conjugate base of the acid as a second precipitate, then isolating the second precipitate to leave a second precipitation step liquor;
(iv) isolating lithium hydroxide from the second precipitation step liquor.

2. A method according to claim 1, wherein the lithium-containing solid is black mass.

3. A method according to claim 1, wherein the first and second bases are different.

4. A method according to claim 1, wherein the acid is sulfuric acid, phosphoric acid, hydrochloric acid, citric acid, or oxalic acid.

5. A method according to claim 1, wherein the acid is sulfuric acid.

6. A method according to claim 1, wherein the second base is a metal hydroxide, preferably barium hydroxide.

7. A method according to claim 1, wherein the first base is ammonium persulfate.

8. A method according to claim 1, wherein before the dissolution step (i) the lithium containing solid is heated to a temperature of 50-100° C.

9. A method according to claim 1, wherein after the dissolution step (i) and before the first precipitation step (ii), solids are removed from the dissolution step liquor.

10. A method according to claim 1, wherein in the first precipitation step a quantity of the first base sufficient to raise the pH of the liquor to pH 3-12.
